(19) United States
(12) Patent Application Publication
(10) Pub. No.: US 2015/0340117 A1
(43) Pub. Date: Nov. 26, 2015

(54) METHOD FOR PRODUCING CONDUCTIVE FILM

(71) Applicant: HANWHA CHEMICAL CORPORATION, Jung-gu, Seoul (KR)

(72) Inventors: Shin Je CHO, Gunpo-si, Gyeonggi-do (KR); Young Kwang KIM, Anyang-si, Gyeonggi-do (KR); Su Young PARK, Seoul (KR); Hana KANG, Suncheon-si, Jeollanam-do (KR); Jeung Hoon PARK, Seoul (KR); Young Chul CHOI, Yongin-si, Gyeonggi-do (KR)

(21) Appl. No.: 14/759,860

(22) PCT Filed: Jan. 9, 2014
(86) PCT No.: PCT/KR2014/000257

§ 371 Date: Jul. 8, 2015

(30) Foreign Application Priority Data
Jan. 9, 2013 (KR) 10-2013-0002485

(51) Int. Cl. H01B 1/04; H01B 13/00; C09D 11/52; B01J 23/78; C01B 31/02

(52) U.S. Cl. CPC H01B 1/04; B01J 23/78; C01B 31/0233; C09D 11/52; H01B 13/0026; C01B 2202/22; Y10S 977/742; Y10S 977/843; Y10S 977/932; B82Y 40/00

(57) ABSTRACT

Provided is a method for producing a conductive film in which a size of a particle of a metal catalyst for synthesizing carbon nanotubes is adjusted to adjust a minor axis diameter of the carbon nanotube, such that the conductive film containing the carbon nanotube having an adjusted diameter may have excellent film properties.

### TECHNICAL FIELD

The present invention relates to a method for producing a conductive film, and more particularly, to a method for producing a conductive film having improved film properties by using a carbon nanotube having an adjusted diameter.

### BACKGROUND ART

A carbon nanotube, which has a shape in which graphite in a hexagonal beehive shape consisting of one carbon atom and three carbon atoms coupled with each other is rolled up in a nano-sized diameter, is a macromolecule having specific and physical properties depending on a size or a shape. The carbon nanotube has a light weight due to a hollow inner portion, and excellent electrical conductivity like copper, excellent thermal conductivity like diamond, and excellent tensile force like steel. Due to a coupling structure having a cylindrical shape, even though a dopant is not intentionally added, the tubes are interacted and changed from a conductor to a semi-conductor. The carbon nanotube is classified into a single walled carbon nanotube (SWCNT), a multi-walled carbon nanotube (MWCNT), and a rope carbon nanotube, depending on a rolled-up shape.

The carbon nanotube has significantly excellent properties such as high strength of several tens GPa grade, an elastic modulus of 1 TPa grade, and excellent electrical conductivity and thermal conductivity exceeding the existing carbon fiber.

In recent years, utilization of the carbon nanotube in a nanoscale using electrical or mechanical unique properties has received attention in various fields. In order to increase utility of the carbon nanotube in various application fields, several utilization materials have been developed. As an example thereof, Korean Laid-Open Publication Patent No. 10-2011-033652 suggests a manufacturing method of highly electrically conductive carbon nanotube-metal composite.

Meanwhile, examples of a method for synthesizing the carbon nanotube include an electrical discharge method, laser deposition, a method using a fluidized bed reactor, a gas-phase growth, and thermal chemical vapor deposition, and in particular, the thermal chemical vapor deposition has advantages in that mass-production is possible, the production cost is reasonable, and a powder typed carbon nanotube may be obtained.

However, as a synthesis yield of the carbon nanotube becomes high, carbon nanotube becoming three-dimensionally tangled frequently occur, which is because growing carbon nanotubes disturb mutual movement, and as a result, largely limits spatial free volume.

In addition, in the existing catalyst for synthesizing carbon nanotube, it is difficult to adjust a size of particles of an actually functioned catalyst metal only by a scheme in which a catalyst solution containing metal salts is prepared and adsorbed on a supporter, and since the metal particles are agglomerated on a supporter, it is difficult to adjust diameter of the carbon nanotube, such that at the time of producing a conductive film using a carbon nanotube, properties of the conductive thin film are required to be adjusted with only weight of the carbon nano tube.

### Technical Problem

An object of the present invention is to provide a method for producing a conductive film in which a minor axis diameter of a carbon nanotube is easily adjusted, a metal catalyst capable of preventing metal particles from being agglomerated on a supporter is used to produce a carbon nanotube, and as compared to the existing carbon nanotube, a diameter of the carbon nanotube in the present invention is small and is easily adjusted, and in a production process thereof, the production cost is decreased and the mass-production is possible.

Another object of the present invention is to provide a conductive film having excellent transmittance and conductivity by easily adjusting a minor axis diameter of a carbon nanotube.

### Technical Solution

The present invention provides a method for producing a conductive film.

In one general aspect, a method for producing a conductive film includes:

(a) preparing a metal catalyst-carbon nanotube composite by synthesizing carbon nanotubes on metal nanoparticles, the carbon nanotube having an adjusted minor axis diameter corresponding to a size of the metal nanoparticle by adjusting the size of the metal nanoparticle supported on a supporter;

(b) preparing a carbon nanotube powder by pulverizing the metal catalyst-carbon nanotube composite;

(c) preparing a conductive ink by introducing the carbon nanotube powder and an additive into a solvent; and

(d) producing a conductive film by coating the conductive ink on a substrate.

The metal nanoparticle may be at least one selected from Fe, Co, Mo, Ni, Se, Y, Cu, Pt, Nb, W, Cr, Ti or oxides thereof, and may have a size of 1 to 30 nm.

The method for preparing the metal nanoparticle according to the embodiment of the present invention may be at least one selected from a sol-gel method, a colloidal method, pyrolysis, thermal or high-frequency plasma method, an electrochemical method and a ball milling method, but the present invention is not limited in view of a kind thereof.

The supporter according to the embodiment of the present invention may be one or two or more selected from a metal particle, an inorganic particle, a metal oxide, a metal hydroxide, and a carbon-based particle, but the present invention is not limited in view of a kind thereof.

The supporter may be one or two or more selected from silica, aluminum oxide, magnesium oxide, zeolite, calcium oxide, strontium oxide, barium oxide, lanthanum oxide, indium oxide, beryllium hydroxide, magnesium hydroxide, calcium hydroxide, strontium hydroxide, barium hydroxide, aluminum hydroxide, titanium hydroxide, chromium hydroxide, vanadium hydroxide, manganese hydroxide, zinc hydroxide, rubidium hydroxide, indium hydroxide, carbon black, carbon fiber, graphite, graphene, carbon nanotube, and carbon nanofiber, and the metal nanoparticle may be used in a content of 5 to 50 parts by weight based on 100 parts by weight of the supporter.

The carbon nanotube powder may be contained in 0.01 to 0.5 parts by weight based on 100 parts by weight of the solvent.

The additive may be at least one selected from a binder, a dispersant, and a wetting agent, and may be contained in 0.1 to 20 parts by weight based on 100 parts by weight of the solvent. The binder may be at least one selected from vinyl resin, polyamide resin, polyester-based hot melt resin, aqueous polyurethane resin, acrylic resin, epoxy resin, melamine resin, styrene resin, acrylic urethane resin, silicone resin, liquid sodium silicate, liquid potassium silicate, liquid lithium silicate, and ethyl silicate, the dispersing agent may be at least one selected from sodium dodecyl sulfate, sodium dodecyl benzene sulfate, polyacetal, acrylic compound, methylmethacrylate, alkyl(C₁˜C₁₀)acrylate, 2-ethylhexylacrylate, polycarbonate, styrene, alphamethylstyrene, vinyl acrylate, polyester, vinyl, polyphenylene ether resin, polyolefin, acrylonitrile-butadiene-styrene copolymer, polyarylate, polyamide, polyamideimide, polyarylsulfone, polyetherimide, polyethersulfone, polyphenylene sulfide, fluorine-based compound, polyimide, polyetherketone, polybenzoxazole, polyoxadiazole, polybenzothiazole, polybenzimidazole, polypyridine, polytriazole, polypyrrolidine, polydibenzofuran, polysulfone, polyurea, polyurethane, and polyphosphazen, and the wetting agent may be at least one selected from a group consisting of a polyether-modified dimethylpolysiloxane copolymer, polyether-modified dimethylpolysiloxane, polyether-modified dimethylpolysiloxane, polydimethylsiloxane of a polyether-modified hydroxy functional group, polyether-modified dimethylpolysiloxane, polyester-modified hydroxy functional polydimethylsiloxane, polyether-modified hydroxy functional polydimethylsiloxane, polyether-modified polydimethylsiloxane, polymethylalkylsiloxane, dimethylpolysiloxane, polyester-modified polymethylalkylsiloxane, polyether-modified polymethylalkylsiloxane and polyester-modified hydroxy polymethylsiloxane.

The preparing of the metal catalyst-carbon nanotube composite may include:

(1) preparing a mixed dispersion by adding a supporter to a metal nanoparticle dispersion prepared by dispersing metal nanoparticles having an adjusted particle size into the solvent;

(2) preparing a metal catalyst by drying, calcination and pulverizing the mixed dispersion; and

(3) preparing the metal catalyst-carbon nanotube composite by synthesizing the carbon nanotubes having a minor axis diameter corresponding to the size of the metal particles on the metal nanoparticle of the metal catalyst using the metal catalyst and a reaction gas containing hydrocarbon gas.

The drying may be performed at 25 to 200 for 1 to 24 hours, the calcination may be performed at 200 to 1000 for 0.1 to 10 hours, and the synthesizing in the step (3) may be performed at 550 to 1000 for 1 to 120 minutes.

### Advantageous Effects

With the method for producing the conductive film according to the present invention, the diameter of the carbon nanotube may be easily adjusted, and as compared to the existing methods, the producing method may be simple, the production cost may be decreased, and the mass-production is possible.

In addition, with the method for producing the conductive film according to the present invention, the carbon nanotube having adjusted diameter by not using the metal salt but using the metal nanoparticles having an adjusted size at the time of preparing the metal catalyst may be easily produced and agglomeration between metal particles on the supporter may be prevented.

Further, with the method for producing the conductive film according to the present invention, the carbon nanotube having small diameter and high purity may be produced, such that transmittance and sheet resistance of the conductive film containing the carbon nanotube may be easily adjusted, and film properties of the conductive film may be improved.

### DESCRIPTION OF DRAWINGS

The above and other objects, features and advantages of the present invention will become apparent from the following description of preferred embodiments given in conjunction with the accompanying drawings, in which:

FIG. 1 is a transmission electron microscope (TEM) photograph of a metal catalyst for producing a carbon nanotube produced by Example 1;

FIG. 2 is a transmission electron microscope (TEM) photograph of a metal catalyst for producing a carbon nanotube produced by Comparative Example 1;

FIG. 3 is a scanning electron microscope (SEM) photograph of a carbon nanotube synthesized by preparation example using the metal catalyst for producing the carbon nanotube produced by Example 1; and

FIG. 4 is a scanning electron microscope (SEM) photograph of a carbon nanotube synthesized by preparation example using the metal catalyst for producing the carbon nanotube produced by Example 2.

### BEST MODE

Hereinafter, a method for producing a conductive film having an excellent film property according to the present invention will be described in detail.

Here, unless technical and scientific terms used herein are defined otherwise, they have meanings understood by those skilled in the art to which the present invention pertains. Known functions and components which obscure the description and the accompanying drawings of the present invention with unnecessary detail will be omitted.

A method for producing a conductive film includes: (a) preparing a metal catalyst-carbon nanotube composite by synthesizing carbon nanotubes on metal nanoparticles, the carbon nanotube having an adjusted minor axis diameter corresponding to a size of the metal nanoparticle by adjusting the size of the metal nanoparticle supported on a supporter; (b) preparing a carbon nanotube powder by pulverizing the metal catalyst-carbon nanotube composite; (c) preparing a conductive ink by introducing the carbon nanotube powder and an additive into a solvent; and (d) producing a conductive film by coating the conductive ink on a substrate.

In the method for producing a conductive film according to the present invention, the size of the metal nanoparticles supported on the supporter is adjusted, such that a minor axis diameter of carbon nanotube grown and synthesized on the metal nanoparticles may be easily adjusted.

In addition, as compared to the existing case of adjusting a content of the metal catalyst and a synthesis temperature to produce the carbon nanotube having a small diameter, in the present invention, the content of the metal catalyst and the size of the metal nanoparticles may be adjusted, such that the diameter of the carbon nanotube may be easily adjusted and more uniform carbon nanotube may be produced.

In particular, at the time of preparing the metal catalyst for synthesizing a carbon nanotube powder, a scheme in which a catalyst solution containing a metal salt is prepared and adsorbed on a supporter is used in the related art; however, in the present invention, metal nanoparticles rather than the metal salt are used, such that the minor axis diameter of the carbon nanotube may be adjusted and agglomeration of the metal particles on the supporter may be prevented.

The metal catalyst-carbon nanotube composite according to the present invention means a material obtained by synthesizing carbon nanotubes having a diameter corresponding to a size of the metal nanoparticle on the metal nanoparticle supported in the supporter and having adjusted particle size, and the carbon nanotube powder means a powder obtained by pulverizing the metal catalyst-carbon nanotube composite.

The metal nanoparticle according to an embodiment of the present invention is not limited, but may be at least one selected from Fe, Co, Mo, Ni, Se, Y, Cu, Pt, Nb, W, Cr, Ti or oxides thereof, and more specifically, may be at least one selected from Fe, Co, Mo, Ni, Se, Y, Cu, Pt, Nb, W, Cr or Ti metal, oxides of the metals, alloys of the metals, or solids of the metals, and may be used as a powder type or an element.

The size of the metal nanoparticle may be 1 to 30 nm so that the minor axis diameter of the carbon nanotube synthesized on the metal nanoparticles supported in the supporter is adjusted. In the case in which the size of the metal nanoparticle is less than 1 nm, it is difficult to synthesize the metal nanoparticle, and the carbon nanotube may not be synthesized from the nanoparticles, and in the case in which the size of the metal nanoparticle is more than 30 nm, since the diameter of the carbon nanotube is large, the conductive film containing the carbon nanotube may have deteriorated film property, and based on the above-description, the size of the metal nanoparticle is preferably 2 to 10 nm.

The method for producing the metal nanoparticle according to the embodiment of the present invention is at least one selected from a sol-gel method, a colloidal method, pyrolysis, thermal or high-frequency plasma method, an electrochemical method and a ball milling method, but the present invention is not limited in view of a kind thereof.

The minor axis diameter of the carbon nanotube according to the embodiment of the present invention may be adjusted and synthesized by the metal nanoparticle; wherein in order to improve properties of the conductive film and dispersion of the carbon nanotube, the diameter of the carbon nanotube may be 2 to 30 nm, and preferably, 3 to 10 nm.

The supporter according to the embodiment of the present invention is not limited, but the diameter of a pore of the porous supporter may be 1 μm to 50 μm in order to effectively achieve a mechanical pulverization to pulverize the supporter by a fine size. The supporter according to the embodiment of the present invention may be one or two or more selected from oxide groups such as silica, aluminum oxide, magnesium oxide, zeolite, calcium oxide, strontium oxide, barium oxide, lanthanum oxide and indium oxide, hydroxide groups such as beryllium hydroxide, magnesium hydroxide, calcium hydroxide, strontium hydroxide, barium hydroxide, aluminum hydroxide, titanium hydroxide, chromium hydroxide, vanadium hydroxide, manganese hydroxide, zinc hydroxide, rubidium hydroxide and indium hydroxide, carbon-based supporter groups such as carbon black, carbon fiber, graphite, graphene, carbon nanotube, and carbon nanofiber, and in order to secure a synthesis yield of the carbon nanotube appropriate for an amount of the catalyst and prevent agglomeration and overlapping between the metal nanoparticles, the metal nanoparticle may be used in a content of 5 to 50 parts by weight, and preferably, 8 to 30 part by weight, based on 100 parts by weight of the supporter.

Hereinafter, the carbon nanotube powder according to the embodiment of the present invention will be described in detail.

The preparing of the metal catalyst-carbon nanotube composite may include:

(1) preparing a mixed dispersion by adding a supporter to a metal nanoparticle dispersion prepared by dispersing metal nanoparticles having an adjusted particle size into the solvent;

(2) preparing a metal catalyst by calcination and pulverizing the mixed dispersion; and

(3) preparing the metal catalyst-carbon nanotube composite by synthesizing the carbon nanotubes having a minor axis diameter corresponding to the size of the metal particles on the metal nanoparticle of the metal catalyst using the metal catalyst and a reaction gas containing a hydrocarbon gas

First, as described above, the metal nanoparticles having an adjusted particle size are dispersed into a solvent to prepare a metal nanoparticle dispersion. A supporter is added to the dispersion, thereby preparing a mixed dispersion. The solvent is not limited, but all solvents are possible as long as the supporter and the metal nanoparticles are well dispersed, and examples of the solvent may include water, alcohol, an organic solvent, and the like.

The metal nanoparticle dispersion and the mixed dispersion may be dispersed by general methods so as to be well-dispersed, wherein an example of the dispersion method, an ultrasonic generator is used for 5 to 120 minutes, but the present invention is not limited thereto.

A metal catalyst is prepared by drying, calcination and pulverizing the prepared mixed dispersion using general methods. The drying process may be performed at 25 to 200 for 1 to 24 hours, the calcination process may be performed at 200 to 1000 for 0.1 to 10 hours, and after the calcination process, the pulverization process may be performed by general method.

Next, the preparing of the metal catalyst-carbon nanotube composite by synthesizing the carbon nanotubes having a minor axis diameter corresponding to the size of the metal particles on the metal nanoparticle of the metal catalyst using the prepared metal catalyst and a reaction gas containing a hydrocarbon gas may be performed. The hydrocarbon gas is not limited, but may be a methane gas, an ethylene gas, an acetylene gas, a propane gas, a butane gas, and the like. In addition, a hydrogen gas and an inert gas may be used as the reaction gas, such that the reaction may be performed.

The synthesizing of the carbon nanotube according to the embodiment of the present invention may be performed at 550 to 1000 for 1 to 120 minutes, and preferably, at 600 to 850 for 10 to 60 minutes in order to smoothly synthesize the carbon nanotube.

When the synthesizing of the carbon nanotube are complete, the metal catalyst-carbon nanotube composite is cooled and pulverized, thereby preparing a carbon nanotube powder.

Then, the prepared carbon nanotube powder and additives are added to a solvent, thereby preparing a conductive ink.

Here, the carbon nanotube powder has a size of 1 to 50 μm and may be contained in 0.01 to 0.5 parts by weight based on 100 parts by weight of the solvent in order to produce a film having appropriate conductivity and transmittance at the time of coating the conductive ink.

At the time of preparing the conductive ink, the solvent is not limited, but may be water, alcohol, an organic solvent, and the like.

In addition, as long as an additive is added in the ink composition for producing a general conductive film, any additives to be added in preparing the conductive ink may be used, and the additive may be at least one selected from a binder, a dispersant, and a wetting agent, and may be contained in 0.1 to 20 parts by weight based on 100 parts by weight of the solvent in order to provide appropriate functionality and appropriate viscosity to the conductive ink.

As the additive according to the embodiment of the present invention, the binder may be at least one selected from a group consisting of organic binders such as vinyl resin, polyamide resin, polyester-based hot melt resin, aqueous polyurethane resin, acrylic resin, epoxy resin, melamine resin, styrene resin, acrylic urethane resin, and silicone resin, or inorganic binders such as liquid sodium silicate, liquid potassium silicate, liquid lithium silicate, and ethyl silicate, the dispersing agent may be at least one selected from sodium dodecyl sulfate, sodium dodecyl benzene sulfate, polyacetal, acrylic compound, methylmethacrylate, alkyl(C₁˜C₁₀)acrylate, 2-ethylhexylacrylate, polycarbonate, styrene, alphamethylstyrene, vinyl acrylate, polyester, vinyl, polyphenylene ether resin, polyolefin, acrylonitrile-butadiene-styrene copolymer, polyarylate, polyamide, polyamideimide, polyarylsulfone, polyetherimide, polyethersulfone, polyphenylene sulfide, fluorine-based compound, polyimide, polyetherketone, polybenzoxazole, polyoxadiazole, polybenzothiazole, polybenzimidazole, polypyridine, polytriazole, polypyrrolidine, polydibenzofuran, polysulfone, polyurea, polyurethane, and polyphosphazen, and the wetting agent may be at least one selected from a group consisting of a polyether-modified dimethylpolysiloxane copolymer, polyether-modified dimethylpolysiloxane, polyether-modified dimethylpolysiloxane, polydimethylsiloxane of a polyether-modified hydroxy functional group, polyether-modified dimethylpolysiloxane, polyester-modified hydroxy functional polydimethylsiloxane, polyether-modified hydroxy functional polydimethylsiloxane, polyether-modified polydimethylsiloxane, polymethylalkylsiloxane, dimethylpolysiloxane, polyester-modified polymethylalkylsiloxane, polyether-modified polymethylalkylsiloxane and polyester-modified hydroxy polymethylsiloxane.

Then, in the producing of the conductive film by coating the prepared conductive ink on a substrate, as long as a substrate is generally used in the conductive film, any substrate may be used, and an example of the substrate, resin films such as PET, PC, and the like, and a glass may be used.

In addition, for coating the conductive ink on the substrate, general methods such as spin coating, bar coating, slot die coating, spray coating, dip coating, and gravure coating may be used.

Therefore, the conductive film according to the embodiment of the present invention may have a sheet resistance of 10⁴ to 10¹⁰ Ω/□, and transmittance of 80 to 92%, and preferably, a sheet resistance of 10⁵ to 10⁸ Ω/□, and transmittance of 85 to 90%. In the above-described ranges, the sheet resistance and the transmittance which are in trade-off relationship have desired ranges, that is, the transmittance is increased and the sheet resistance is decreased, such that the conductive film having excellent film properties in the above-described ranges may be achieved.

Hereinafter, although the constitution and effects of the present invention have been specifically described by the specific examples and comparative examples, it will be appreciated that the following examples are merely described for illustrative purposes, and the present invention is not limited thereto.

### EXAMPLE 1

### Preparation of Metal Catalyst for Producing Carbon Nanotube

1. 40 g of iron oxide nanoparticles having a particle size of 3 nm (purity: 35%, manufactured by Hanwha Chemical Co., Ltd.) was added to 100 mL of n-hexane and an ultrasonic generator in a probe scheme was used for 30 minutes, thereby preparing a metal nanoparticle dispersion. In the case in which a solid content is not completely dissolved, the dispersion was dispersed again using an ultrasonic generator for 30 minutes.

2. 200 g of a magnesium oxide (MgO) powder (particle size: 10 um, manufactured by Duksan Company) as a supporter was added to the prepared iron oxide nanoparticle-dispersed solution, and dispersed again using an ultrasonic generator for 30 minutes, thereby preparing a catalyst slurry.

3. The prepared catalyst slurry was dried in a box typed oven at 150 for 16 hours, and the dried catalyst was pulverized in 300 cc of mixer for 10 seconds five times. At the time of pulverization for 10 seconds, the catalyst was sufficiently fluidized and pulverized by shaking the mixer up and down. The pulverized catalyst was examined by visual or tactile sensation and in the case of detecting the non-pulverized particles, the pulverizing process was repeated.

4. The pulverized catalyst was cacinated in a box typed oven at 500 for 30 minutes, thereby preparing a metal catalyst.

### EXAMPLE 2

A catalyst of Example 2 was prepared by the same method as Example 1 above except for adding 23 g of iron oxide nanoparticles having a particle size of 10 nm (purity: 60%, manufactured by Hanwha Chemical Co., Ltd.).

### COMPARATIVE EXAMPLE 1

1. 34.16 g of iron (III) nitrate nonahydrate was put into 100 mL of distilled water, mixed with a magnetic stirrer for 10 minutes, and completely dissolved, thereby preparing a transition metal precursor solution.

2. 200 g of a magnesium oxide powder as a supporter was added thereto, and mixed with a mechanical stirrer, thereby preparing a catalyst slurry.

3. The prepared catalyst slurry was dried in a box typed oven at 150 for 16 hours, and the dried catalyst was pulverized in 300 cc of mixer for 10 seconds five times, thereby preparing a powdered catalyst.

4. The pulverized catalyst was cacinated in a box typed oven at 500 for 30 minutes, thereby preparing a metal catalyst.

### COMPARATIVE EXAMPLE 3

1. 34.16 g of iron (III) nitrate nonahydrate and 500 g of magnesium nitrate hexahydrate were put into 100 mL of distilled water, mixed with a magnetic stirrer for 10 minutes, and completely dissolved, thereby preparing a catalyst precursor aqueous solution.

2. 100 g of ammonium carbonate as a pH adjuster was put into 400 mL of distilled water, mixed and completely dissolved using a bath type ultrasonicator for 2 hours, thereby preparing a pH adjusting solution.

3. The prepared catalyst precursor aqueous solution was stirred with a mechanical stirrer, a pH adjusting solution in an amount of 15 ml/min was added thereto using a dropping funnel, and a pH meter was used to adjust pH of the solution to 7.5 in real time, thereby preparing a catalyst mixture.

4. The prepared catalyst mixture was filtered under reduced pressure in a Buchner funnel to filter a precipitate, and each 1 L of distilled water was poured three times to wash the filtrate, followed by drying in a box typed oven at 150 for 16 hours. The dried catalyst was pulverized in 300 cc of mixer for 10 seconds five times, thereby preparing a powdered catalyst.

### EXAMPLE 3

### Preparation of Carbon Nanotube Powder

A carbon nanotube was produced by a thermal chemical vapor method using the metal catalysts prepared by Examples 1 and 2 and Comparative Examples 1 and 2. The producing method thereof is as follows. 1 g of metal catalyst was uniformly applied a rectangular quartz boat and was positioned at the center of a horizontal typed reaction furnace consisting of quartz tube having a diameter of 190 mm. When a temperature was increased at a rate of 10/min to reach 750 under nitrogen atmosphere, the introduction of nitrogen gas was terminated, and an ethylene gas (1SLM) and a hydrogen gas (2SLM) which are reaction gas were supplied at a ratio of 1:2 for 30 minutes, thereby synthesizing carbon nanotubes on metal nanoparticles supported on a surface of the supporter. When the synthesis was complete, the quartz boat positioned in the center was moved to an entrance while terminating the introduction of the ethylene gas and the hydrogen gas and supplying an argon gas, and cooled for 30 minutes, wherein in the case in which a temperature in the reaction furnace was decreased below 200, the quartz boat was took out and metal catalyst carbon nanotube composite was collected and pulverized, thereby preparing a carbon nanotube powder.

### EXAMPLE 4

### Preparation of Conductive Ink

0.1 g of the carbon nanotube powder prepared by Example 3 above was added to 200 mL of a deionized water, 0.3 g of sodium dodecyl sulfate as a dispersant was added thereto, and an ultrasonic generator in a probe scheme was used for 60 minutes to disperse the mixture. After 20 g of urethane-based binder (PU-147, Chempia Company) as a binder and 1 g of polyether-modified dimethyl polysiloxane-based (BYK-333, BYK Company) as a wetting agent were added thereto, the reactant was mixed using a stirrer for 20 minutes, thereby preparing a conductive ink.

### EXAMPLE 5

### Production of Conductive Film

The conductive ink prepared by Example 4 above was coated on a PET substrate having a length and a width of 20 cm, respectively, using D-Bar #4 by a bar coating method, dried at 70 for 20 seconds, thereby producing a conductive film.

### EXPERIMENTAL EXAMPLE 1

### Analysis on Catalyst Shape

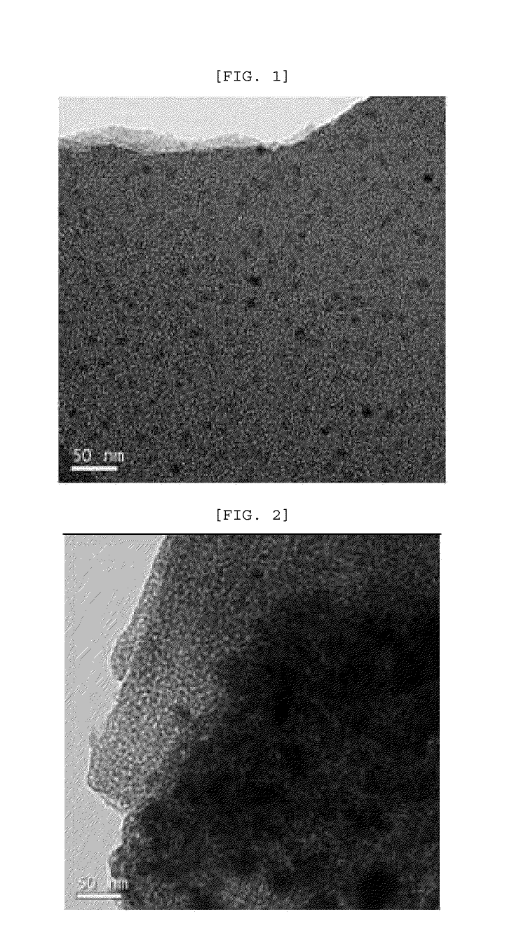

Shapes of metal catalysts for producing the carbon nanotubes prepared by Example 1 and Comparative Example 1 above were observed by transmission electron microscope (TEM), a photograph of Example 1 above was shown in FIG. 1 and a photograph of Comparative Example 1 was shown in FIG. 2.

After analysis, it was observed that in the metal catalyst for producing the carbon nanotube prepared by Example 1, metal nanoparticles having a regular size were uniformly supported on a surface of the magnesium oxide supporter; however, it was observed that in the catalyst for producing the carbon nanotube prepared by Comparative Example 1, metal nanoparticles having an irregular size were supported.

### EXPERIMENTAL EXAMPLE 2

### Analysis on Diameter of Carbon Nanotube

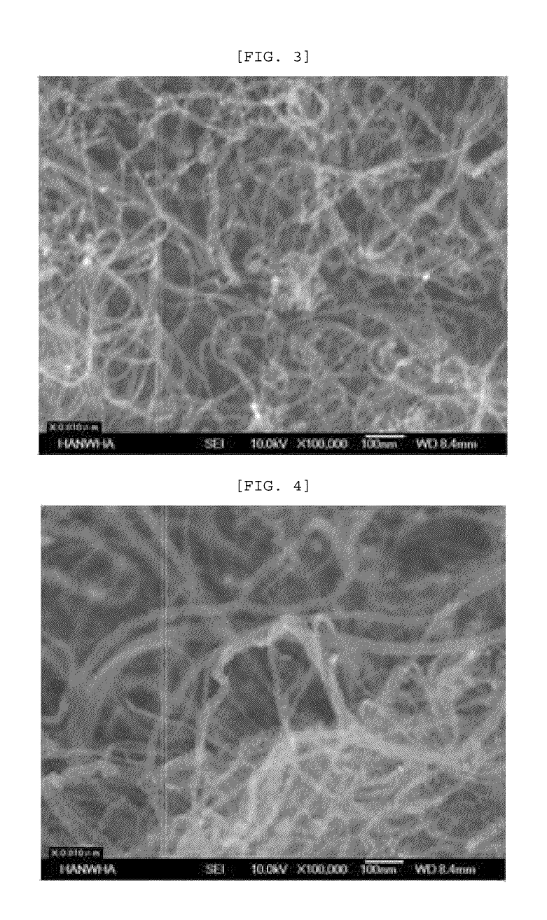

A diameter of the carbon nanotube synthesized by Example 3 above was observed by scanning electron microscope (SEM) and transmission electron microscope (TEM), and the measurement results were summarized in the following Table 1. In addition, shapes in scanning electron microscope were shown in FIG. 3 (the metal catalyst of Example 1 was used) and FIG. 4 (the metal catalyst of Example 2 was used), respectively.

### EXPERIMENTAL EXAMPLE 3

### Evaluation on Conductive Film Property

In order to evaluate properties of conductive film produced by Example 5 above, transmittance was measured by using NDH 500W equipment to scan the entire region in a visible ray, and a sheet resistance of the conductive film was measured by using a four-point probe low resistivity meter (Loresta-GP, MCP-T610) and results thereof were summarized in the following Table 1.

TABLE 1

| Used Metal | | | Comparative | Comparative |
|---|---|---|---|---|
| Catalyst | Example 1 | Example 2 | Example 1 | Example 2 |
| CNT Diameter (nm) | 3~6 | 9~12 | 7~25 | 7~25 |
| Transmittance (%) | 89 | 87 | 85 | 87 |
| Sheet Resistance | 10^{5.4} | 10^{6.1} | 10^{8.2} | 10^{9.1} |
| (Ω/□) | | | | |

As shown in Table 1 above, in the carbon nanotube according to the producing method of the present invention, the diameter thereof may be adjusted and uniform. That is, the size of the metal nanoparticles may be adjusted to easily adjust the diameter of the carbon nanotube, such that the transmittance and the sheet-resistance properties of the conductive film containing the carbon nanotube may be improved, and adjusted so as to have a desired range.

Further, the carbon nanotube having a small diameter may be produced by a simple process, such that the conductive film having excellent transmittance and low sheet-resistance may be produced.

1. A method for producing a conductive film comprising:
(a) preparing a metal catalyst-carbon nanotube composite by synthesizing carbon nanotubes on metal nanoparticles, the carbon nanotube having an adjusted minor axis diameter corresponding to a size of the metal nanoparticle by adjusting the size of the metal nanoparticle supported on a supporter;
(b) preparing a carbon nanotube powder by pulverizing the metal catalyst-carbon nanotube composite;
(c) preparing a conductive ink by introducing the carbon nanotube powder and an additive into a solvent; and
(d) producing a conductive film by coating the conductive ink on a substrate.

2. The method of claim 1, wherein the metal nanoparticle has a size of 1 to 30 nm.

3. The method of claim 1, wherein the metal nanoparticle is at least one selected from Fe, Co, Mo, Ni, Se, Y, Cu, Pt, Nb, W, Cr, Ti or oxides thereof.

4. The method of claim 1, wherein the supporter is at least one selected from silica, aluminum oxide, magnesium oxide, zeolite, calcium oxide, strontium oxide, barium oxide, lanthanum oxide, indium oxide, beryllium hydroxide, magnesium hydroxide, calcium hydroxide, strontium hydroxide, barium hydroxide, aluminum hydroxide, titanium hydroxide, chromium hydroxide, vanadium hydroxide, manganese hydroxide, zinc hydroxide, rubidium hydroxide, indium hydroxide, carbon black, carbon fiber, graphite, graphene, carbon nanotube, and carbon nanofiber.

5. The method of claim 1, wherein the metal nanoparticle is used in a content of 5 to 50 parts by weight based on 100 parts by weight of the supporter.

6. The method of claim 1, wherein the carbon nanotube powder is contained in 0.01 to 0.5 parts by weight based on 100 parts by weight of the solvent.

7. The method of claim 1, wherein the additive is at least one selected from a binder, a dispersant, and a wetting agent, and is contained in 0.1 to 20 parts by weight based on 100 parts by weight of the solvent.

8. The method of claim 7, wherein the binder is at least one selected from vinyl resin, polyamide resin, polyester-based hot melt resin, aqueous polyurethane resin, acrylic resin, epoxy resin, melamine resin, styrene resin, acrylic urethane resin, silicone resin, liquid sodium silicate, liquid potassium silicate, liquid lithium silicate, and ethyl silicate,
the dispersing agent is at least one selected from sodium dodecyl sulfate, sodium dodecyl benzene sulfate, polyacetal, acrylic compound, methylmethacrylate, alkyl(C₁˜C₁₀)acrylate, 2-ethylhexylacrylate, polycarbonate, styrene, alphamethylstyrene, vinyl acrylate, polyester, vinyl, polyphenylene ether resin, polyolefin, acrylonitrile-butadiene-styrene copolymer, polyarylate, polyamide, polyamideimide, polyarylsulfone, polyetherimide, polyethersulfone, polyphenylene sulfide, fluorine-based compound, polyimide, polyetherketone, polybenzoxazole, polyoxadiazole, polybenzothiazole, polybenzimidazole, polypyridine, polytriazole, polypyrrolidine, polydibenzofuran, polysulfone, polyurea, polyurethane, and polyphosphazen, and
the wetting agent is at least one selected from a group consisting of a polyether-modified dimethylpolysiloxane copolymer, polyether-modified dimethylpolysiloxane, polydimethylsiloxane of a polyether-modified hydroxy functional group, polyester-modified hydroxy functional polydimethylsiloxane, polyether-modified hydroxy functional polydimethylsiloxane, polyether-modified polydimethylsiloxane, polymethylalkylsiloxane, dimethylpolysiloxane, polyester-modified polymethylalkylsiloxane, polyether-modified polymethylalkylsiloxane and polyester-modified hydroxy polymethylsiloxane.

9. The method of claim 1, wherein the preparing of the metal catalyst-carbon nanotube composite includes:
(1) preparing a mixed dispersion by adding a supporter to a metal nanoparticle dispersion prepared by dispersing metal nanoparticles having an adjusted particle size into the solvent;
(2) preparing a metal catalyst by drying, calcination and pulverizing the mixed dispersion; and
(3) preparing the metal catalyst-carbon nanotube composite by synthesizing the carbon nanotubes having a minor axis diameter corresponding to the size of the metal particles on the metal nanoparticle of the metal catalyst using the metal catalyst and a reaction gas containing a hydrocarbon gas.

10. The method of claim 9, wherein the drying is performed at 25 to 200 for 1 to 24 hours, and the calcination is performed at 200 to 1000 for 0.1 to 10 hours.

11. The method of claim 9, wherein the synthesizing in the step (3) are performed at 550 to 1000 for 1 to 120 minutes.
